(19) United States
(12) Patent Application Publication
(10) Pub. No.: US 2026/0069500 A1
(43) Pub. Date: Mar. 12, 2026

(54) Device and Method for Cosmetic Use

(71) Applicant: L&R Kältetechnik GmbH & Co. KG, Sundern (DE)

(72) Inventor: Lothar Abels, Nörvenich (DE)

(21) Appl. No.: 19/314,569

(22) Filed: Aug. 29, 2025

Related U.S. Application Data
(63) Continuation of application No. PCT/EP2024/055078, filed on Feb. 28, 2024.

(30) Foreign Application Priority Data
Mar. 1, 2023 (DE) 102023105101.6

(51) Int. Cl. A61H 33/14; A61H 23/00; A61H 33/06

(52) U.S. Cl. CPC A61H 33/14; A61H 23/00; A61H 33/066; A61H 2033/141; A61H 2201/0188; A61H 2201/102; A61H 2230/805; A61H 2230/825

(57) ABSTRACT

A device for cosmetic application comprises an application cabin including: an interior space; application apparatuses; and a control unit. The application apparatuses are individually controllable through the control unit via an operating unit. At least one of the application apparatuses comprises an ion apparatus to supply ionized air into the interior space. A method for operating the device for cosmetic application includes: recording, via the operating unit, user data, the user data include weight, age, and height of a user; determining application parameters from the user data, the application parameters including an application duration and an application intensity of individual ones of the application apparatuses; creating an application plan for coordinating individual cosmetic applications by the individual one of the application apparatuses, including a temporal sequence of applications; and controlling the individual one of the application apparatuses using the application plan.

### CROSS REFERENCE TO RELATED APPLICATIONS

This application is a continuation of International Application No. PCT/EP2024/055078, filed on Sep. 6, 2024, which claims priority under 35 U.S.C. § 119 (a)-(d) to German patent application No. 10 2023 105 101.6, filed on Mar. 1, 2023, the entire contents of which are hereby incorporated by reference.

### TECHNICAL FIELD

The present invention relates to a device for cosmetic external application in healthy humans and a method for operating the device.

### BACKGROUND

Various devices for cosmetic application in healthy humans are known from the prior art. For example, an infrared sauna with a plurality of infrared lamps is known from the prior art. The infrared lamps can be used to expose areas of the human body to heat radiation. The application of heat can help to relax the muscles, thereby increasing a person's sense of well-being and achieving a cosmetic effect. A disadvantage of this is that the body temperature of a person in the sauna cabin can be regulated only very imprecisely. In particular, temperatures that are too high or too low can cause a person to feel stressed and uncomfortable, so that the cosmetic effect for the person achieved by its application is not optimal.

Furthermore, a device has become known through which air can be ionized. Therein, a person lies down in the device or positions themselves in front of the device in order to come into contact with the ionized air particles. The ionized air has a vitalizing and invigorating effect. Further, this can also have a positive effect on blood circulation. A cosmetic effect can be achieved. A disadvantage herein is that a person's breathing becomes significantly shallower, meaning that only a relatively small amount of air is taken in by the person if they do not feel comfortable. A cosmetic effect is therefore only conditionally present and dependent on the specific application and external influences.

Therefore, an objective of the disclosed device and method of operating the device is to achieve an improved cosmetic application result.

### SUMMARY

The disclosed device for cosmetic external application in a healthy person for improving general well-being comprises a closable application cabin with an interior space, wherein the application cabin comprises a plurality of application apparatuses. The application apparatuses can be controlled individually through a control unit with an operating unit. At least one application apparatus is designed as at least one ion apparatus for feeding ionized air into the interior space of the application cabin.

The device has many advantages. A significant advantage of the device is that the device comprises a plurality of application apparatuses. This allows different cosmetic applications to be carried out simultaneously. The cosmetic effects of the individual application apparatuses, in particular in combination with the ion apparatus, have a positive influence on each other, so that combined application results in an overall cosmetic effect which, as a whole, has a greater effect than the individual cosmetic applications alone. Another advantage is that the application apparatuses can be controlled individually by the control unit, so that the temporal sequence of the individual applications can be coordinated in individual parameters, such as application intensity and duration, in order to further improve the achievable combined cosmetic effect, in particular depending on specific user data, such as body size, body weight, or the like.

Advantageously, the application cabin, and in particular the interior space of the application cabin, can be closed by a door, such as a glass door. Advantageously, through this, the effect of the application apparatuses, such as the ion apparatus, is optimized, as the ionized air is enclosed within the application cabin.

Ionized air has a vitalizing effect on the human organism. In combination with other cosmetic application apparatuses, an improved cosmetic effect can be achieved.

The individual application apparatuses are preferably connected to the control apparatus. The individual application apparatuses are preferably electrically connected to the control unit. In particular, the control unit comprises at least one programmable computer unit, through which the function of the individual application apparatuses can be coordinated with each other. In particular, the control unit can control the individual application apparatuses individually and independently of one another.

In particular, ionized air has a positive effect on a person's well-being when absorbed through the skin and respiratory tract. Beyond that, ionized air has a beneficial disinfecting and germicidal effect, so that the appearance of the skin can improve. Ionized air can also result in other positive cosmetic effects on the skin, such as promoting blood circulation.

Preferably, at least one application apparatus is designed as a lighting apparatus for lighting application. In particular, the lighting apparatus comprises at least one light emitting diode (LED) unit. Advantageously, through the application of lighting, a positive effect on a person's well-being, such as influencing appetite, mood, or emotional state, or even temperature perception, through which the immune system is triggered as well, can be achieved.

Further, a change in body posture or muscle tension is possible. In particular, the lighting apparatus can produce different colors within the visible color spectrum, such as red, yellow, blue, green, white, or the like.

In particular, the LED unit comprises one or more LED strips, which are preferably arranged on the walls of the cabin. Advantageously, the LED strips can be controlled individually, so that a targeted application of lighting in specific regions of the body, such as, for example, the upper body or the face, is possible. This also offers the possibility of controlling a specific combination of colors and color changes sequentially or simultaneously in order to accelerate the benefit of the application for the person.

Particularly preferably, at least one application apparatus is designed as a heating apparatus for applying heat. In particular, the heating apparatus comprises at least one infrared unit. Advantageously, heat can have a positive effect on cosmetic applications, for example by promoting the opening of the pores of the skin so that dirt and impurities can leave the pores. Further, the enlargement of the skin's surface results in increased oxygen uptake, which is further improved in particular in conjunction with ionized air.

Preferably, at least one application apparatus is designed as a sound apparatus for audiophile use in the interior space. Particularly preferably, the sound apparatus comprises, for example, at least one loudspeaker, which is arranged on an inner wall of the application cabin. Advantageously, the sound apparatus can generate tones or sounds that can have a positive effect on a person's well-being. Further, through the targeted use of tones or sounds a cosmetic effect, such as posture correction through relaxation and/or an increase in well-being can be achieved, in particular in conjunction with the use of a heating apparatus or an ion apparatus.

Expediently, at least one application apparatus is designed as a ventilation apparatus for generating a thermal effect. Advantageously, through the ventilation apparatus, an air flow in the interior space of the application cabin can be generated. Preferably, the ventilation apparatus comprises at least one rapid ventilation system through a cabin ceiling for generating a rapid drop in temperature through rapid exchange of air. Further, through the air flow, a convective heat transfer can be influenced. Through this, a heat dissipation from the human body and also the perception of temperature on a person's skin can be influenced. Further, odors can be quickly and effectively neutralized through a rapid air exchange, e.g., to enable exchanging the air between two users. Advantageously, rapid ventilation through the ceiling of the application cabin can enable the forming of an air flow along the entire body height of a person in a walk-in application cabin, which is perceived as particularly intensive.

Advantageously, at least one application apparatus is designed as an aromatherapy apparatus for aromatherapeutic application. Advantageously, the aromatherapy apparatus comprises at least one fragrance unit for providing at least one fragrance sample. Advantageously, the fragrance sample can be used to introduce a fragrance into the interior space of the application cabin. Fragrances can advantageously increase relaxation and well-being, so that the muscles relax and tension is released. Further, fine fragrance particles can have a positive effect on the skin, smoothing and tightening it. Particularly advantageously, such a fragrance application is in combination with ionized air, heat, or lighting as well. Advantageously, a fragrance can be distributed particularly quickly and evenly within the application cabin by means of an air flow. Preferably, the fragrance unit can actively distribute the fragrance in the environment and comprise a spray head or the like for this purpose.

Advantageously, the fragrance unit comprises replaceable cartridges in which the fragrance samples are provided. The cartridges are held in an exchangeable holder. Preferably, the exchangeable holder is arranged on the roof of the application cabin above the cabin ceiling. As consumables, the cartridges are exchangeable. Advantageously, the fragrance unit comprises at least one pump for pumping the fragrance samples into the interior space of the application cabin. Advantageously, the fragrance sample can be coordinated with the operation of the other application apparatuses so that, for example, fragrance and/or color and/or temperature and/or the like are coordinated with each other. Advantageously, the pump is arranged in the ion channel of the ion apparatus. Advantageously, the intake air is enriched with fragrance samples from the cartridges by means of, in particular, three injection nozzles. Through that, the fragrance can be introduced into the interior space of the application cabin with the ionized air.

The operating unit is preferably designed as a tablet computer or the like. Advantageously, a tablet computer can have a wireless communication connection with the control unit. Preferably, the device can thus be controlled from the interior space or outside the application cabin.

Preferably, at least one temperature sensor unit is included for monitoring the temperature in the interior space of the application cabin. Advantageously, the temperature sensor unit is operatively connected to the control unit and can be used to control the individual application apparatuses. The temperature sensor unit preferably comprises at least one temperature sensor for measuring the temperature of the air in the interior space of the application cabin and/or on the surface of a person's skin and/or on the surface of the inner wall of the cabin. Particularly advantageously, the temperature unit can be used to control the cosmetic application within the application cabin in order to enable control of the application apparatuses depending on the surface temperature of the skin, so that, for example, the pores of the skin contract or open in a targeted manner.

Preferably, at least one distance monitoring unit is included for monitoring a user position in the application cabin. In particular, the distance monitoring unit comprises one or more distance sensors, such as an ultrasonic sensor or an optical sensor, such as a camera or the like, for determining the position of a user within the application cabin. Preferably, the distance sensors are arranged within the application cabin in the walls and/or a ceiling of the application cabin. Advantageously, the distance monitoring unit is operatively connected to the control unit. Advantageously, the distance monitoring unit can determine feedback about the position of the user within the application cabin, in particular to the ion apparatus and/or to a heating apparatus. Preferably, feedback can be provided to the user via the operating unit so that an application result is optimized.

Advantageously, a person can enter the application cabin. Preferably, a person can stand upright in the interior space of the application cabin. Advantageously, the application cabin, and in particular the interior space, has a height between 1500 mm and 3000 mm or even more and/or a width between 1000 mm and 3000 mm, wherein even wider application cabins are possible, and/or a depth between 1500 mm and 3000 mm, wherein even deeper cabins are possible. The application cabin can preferably be designed so that it can be entered by one or more people at the same time. In addition, application cabins with significantly smaller dimensions are also possible, e.g., for individual parts of the body such as the hands, the lower body, the head, or the upper body only.

Preferably, at least one vibration unit is comprised. Advantageously, the vibration unit enables the transmitting of vibrations to the person's body. Through this, muscle contractions can be promoted, through which the exchange of oxygen can be intensified. Advantageously, the intensity can be in connection with other application apparatuses. Advantageously, the vibration unit is arranged such that a person can stand on the vibration unit in the interior space of the application cabin. Advantageously, the vibration unit comprises one or more vibration plates which vibrate during operation and transmit these vibrations through the feet into the person's body. Advantageously, the intensity of the application can be influenced by the position of the person on the vibration unit. For example, different muscle groups can be targeted by positioning the stretched legs close together or wide apart, or even in an angled squatting position, which can also influence oxygen uptake. Advantageously, the human body can be particularly well stimulated, so that brown body fat, which is harmful to the organism, can be broken down, in particular in combination with the other application apparatuses.

Preferably, the application cabin has a wall with at least one insulation layer. Advantageously, the insulation layer enables the thermal and/or acoustic insulation of the application cabin in relation to the environment. Advantageously, through that, the optimization of the application result for the user can be optimized.

In particular, the application cabin is at least partially made of aluminum. The interior panels are preferably made of stainless steel with a wall thickness between 1 mm and 2 mm, preferably 1.5 mm. The interior panels are preferably suspended from the cabin walls using a suspension device. Advantageously, the application cabin is not magnetically conductive and is particularly light. Further advantageously, the application cabins made of aluminum can also be used without any problems in environments with high humidity, such as damp rooms or outdoors, as they do not rust. The application cabin can preferably also be made at least partially from other materials, such as, for example, wood or carbon.

The application cabin preferably includes suspensions for the individual application apparatuses, in particular stainless steel application apparatuses. In particular, the suspensions are at least partially made of stainless steel. Advantageously, through this, the suspensions are particularly resistant to corrosion. Preferably, the suspensions are between 0.5 and 2 mm thick, and particularly preferably approximately 1.5 mm thick.

The method according to the invention for operating a device as previously described comprises at least the following steps:

Recording of user data, such as weight, age, and height, through the operating unit; and

Deriving application parameters from the user data, such as, in particular, an application duration, application intensity of the individual application apparatuses or the like; and

Creation of an application plan for coordinating individual cosmetic applications by the application apparatuses and, in particular, their temporal sequence (relative to each other);

Controlling the individual application apparatuses using the application plan.

The method according to the disclosure has many advantages. A significant advantage of the method for operating the device is an improvement in the cosmetic effects that can be achieved by the application apparatuses, e.g., skin tightening through light treatment and contact with ionized air, for example in combination with heat. Advantageously, an improved cosmetic effect can be achieved through the method. Through the recording of user data such as age, height, weight, and other parameters or user characteristics, a cosmetic application through the device can be optimized. In particular, the recorded user parameters are transmitted to the control unit, which uses them to create an application program that can be customized, preferably by a person as the user, in particular according to their wishes. Advantageous further developments of the method are apparent from the entire application.

Preferably, the ion apparatus for cosmetic application comprises at least one ion channel for air flow and an ion source unit for generating negatively charged ions in the air and a fan unit for directing the air through the ion channel and through the ion source unit. A significant advantage of the ion apparatus is that it enables ionization of the air that is fed into the application cabin, which has a vitalizing effect on the human organism.

The ion source unit preferably comprises a high-voltage cascade and, in particular, three high-voltage cascades, each with one output, for ionizing the air. Advantageously, the high-voltage cascades enable a particularly efficient ionization of the air.

In particular, the ion source unit has a brush unit, and in particular three brush units, for generating the ions. Advantageously, through the three brush units, a particularly homogeneous ionization of the air in the ion channel can be enabled, so that the ionization performance is optimized.

Advantageously, the ion channel has at least a partially rigid wall, in particular made of a metal, in particular an angled metal, preferably stainless steel. Advantageously, the wall is designed to be smooth in terms of fluid mechanics. Particularly advantageously, through this, the flow resistance is minimized, so that a particularly high air throughput and uniform air guidance are possible. This results in optimal functioning of the ionization apparatus. Preferably, the ion channel has a rectangular cross-section, which is particularly space-saving.

Preferably, the fan unit comprises at least three axial fans, which draw the room air through the channel in a filtered manner and conduct the ionized air to the outside, in particular into the interior space of an application cabin. Advantageously, the axial fans are connected in series or in parallel so that either a particularly intense air flow or a particularly high air throughput is possible. Advantageously, in a parallel connection, there is an air outlet along a particularly large area, such as the upper body of a person.

Advantageously, the ion concentration in the ionized air of the ion apparatus can be regulated. Advantageously, the ion concentration can be regulated directly by changing the voltage input of the ion apparatus. Advantageously, through this, the ion concentration can be adjusted to the user data of a person.

Further advantageous developments and features of the disclosed device and method are apparent from the example embodiments, which are explained below with reference to the accompanying figures.

It is not necessary that a device, method, and ion apparatus according to the disclosure have all of the features described below. It is also possible that only individual features of the example embodiments described below are present.

### BRIEF DESCRIPTION OF THE DRAWINGS

FIG. 1 is a purely schematic view of a device according to the disclosure in a perspective view;

FIG. 2 is a purely schematic front view of the device according to the disclosure;

FIG. 3 is a purely schematic perspective view of the interior space of the device according to the disclosure;

FIG. 4 is purely schematic views of the ion apparatus used within the device according to the disclosure.

### DETAILED DESCRIPTION

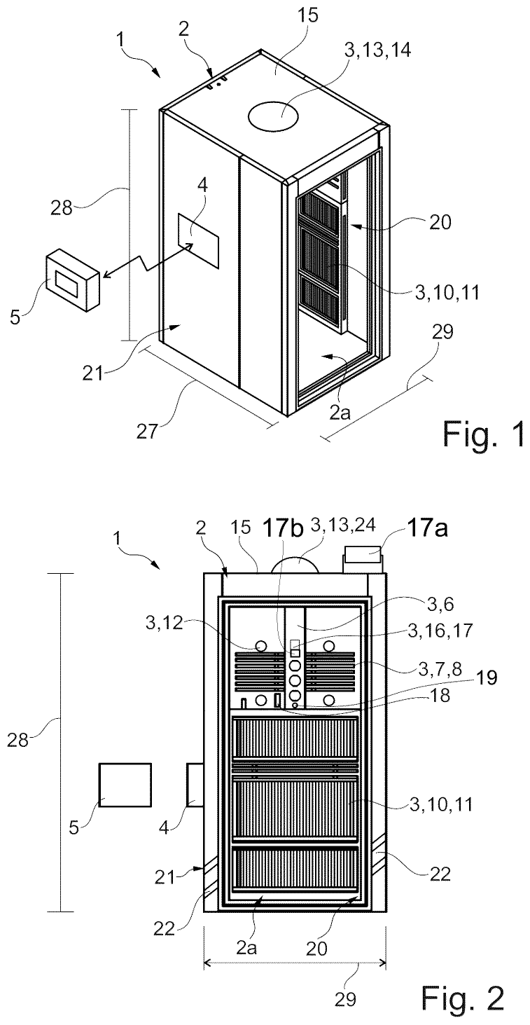

FIG. 1 shows a purely schematic view of a device 1 according to the disclosure in a perspective view. The device 1 comprises an application cabin 2 with an interior space 2a and a plurality of application apparatuses 3. The application apparatuses 3 can be individually controlled through the control unit 4 with an operating unit 5. At least one application apparatus 3 is designed as an ion apparatus 6 for supplying ionized air into the interior space 2a. The combination of the application apparatuses 3 improves the cosmetic effect that can be achieved compared to the individual use of the application apparatuses 3. The interior space 2a of the application cabin 2 can be closed by a door which is not shown, so that the effect of the application apparatuses 3 and in particular of the ion apparatus 6 is improved, as the ionized air is retained within the interior space 2a of the application cabin and cannot simply be conducted into the environment.

Here, the operating unit 5 of the control unit 4 is designed as a tablet. The tablet is connected to the control unit 4 via a wireless radio connection. This allows the device 1 to be operated from the interior space 2a or from outside the application cabin 2.

The device 1 further comprises a heating apparatus 10 with a plurality of infrared units 11, which are designed as heating plates 11 and are arranged on the inner walls 20 of the application cabin 2a. The heating plates can be controlled individually through the control unit 4.

The device 1 further comprises an application apparatus 3, which is designed as a ventilation apparatus 14 with a rapid ventilation in the cabin ceiling 15 of the application cabin 2a. Through a particularly rapid exchange of air a rapid drop in temperature in the interior space 2a of the application cabin 2 can also be enabled.

The application cabin 2 can be entered by a person and has a height 28 of 2500 mm, a width 29 of 1200 mm and a depth 27 of 1500 mm, so that a person can comfortably stand upright in the interior space 2a of the application cabin 2. The interior space 2a of the application cabin 2 can be closed by a door which is not shown here and can be separated from the environment.

FIG. 2 shows a purely schematic front view of the device 1 according to the invention. The application apparatus 3, designed as an ion apparatus 6, is arranged centrally along the width 29 of the application cabin 2a. Light emitting diode (LED) units 8, designed as lighting apparatuses 7, are arranged to the side of the ion apparatus 6 and extend as LED lighting strips 8 over part of the width 29 of the interior space 2a of the application cabin 2. The application apparatus 3 designed as a heating apparatus 10 is arranged in the lower area of the interior space 2a of the application cabin 2. The heating apparatus comprises a plurality of infrared heating plates 10, which extend along the inner walls 20 of the application cabin 2 and can warm a person directly through heat radiation.

Further comprised, an application apparatus 3 designed as a sound apparatus 12 is present. Here, the sound apparatus 12 comprises multiple loudspeakers 12, which are arranged on the inner wall 20 of the application cabin 2 and through which sounds and tones can be generated during cosmetic application.

Here, the application apparatus 3 designed as a ventilation apparatus 13 is designed as a rapid ventilation 14 in the cabin ceiling 15. Through the rapid ventilation 14, air from the interior space 2a of the application cabin 2 can be extracted upwards. Through this, a particularly rapid and efficient air exchange can be enabled, which can also result in a rapid drop in temperature.

Between the inner wall 20 and the outer wall 21, an insulation layer 22 is provided which insulates the interior space 2a from the outside so that environmental influences are at least reduced when the application cabin 2a is used by a person.

In addition, the device 1 comprises an application apparatus 3 designed as an aromatherapy apparatus 16. Here, the aromatherapy apparatus 16 comprises a fragrance unit 17 through which a fragrance can be introduced into the interior space 2a of the application cabin 2. Therein, the fragrance is actively dispersed and is arranged around ion channel 9 of the ion apparatus.

Aside from that, a temperature sensor unit 18 with a temperature sensor 18 is provided here on the inner walls 20 of the application cabin 2a, which detects the temperature in the interior space 2a of the application cabin 2a, i.e., the air temperature or surface temperature of the air. The temperature sensor unit 18 is connected to the control unit 4 so that the measured temperature can be used to control the individual application apparatuses 3 and, in particular, the heating apparatus 10.

Aside from that, the device 1 here has a distance monitoring unit 19 with a distance sensor 19. The distance monitoring unit 19 can be used to determine the position of a person inside the application cabin 2a. The distance monitoring unit 19 is also connected to the control unit 4 so that the application apparatuses 3 can be controlled depending on the measured distance. Through that, optimal positioning of the person within the application cabin 2a is possible. Further, the person can receive feedback via the operating unit 5 and the tablet.

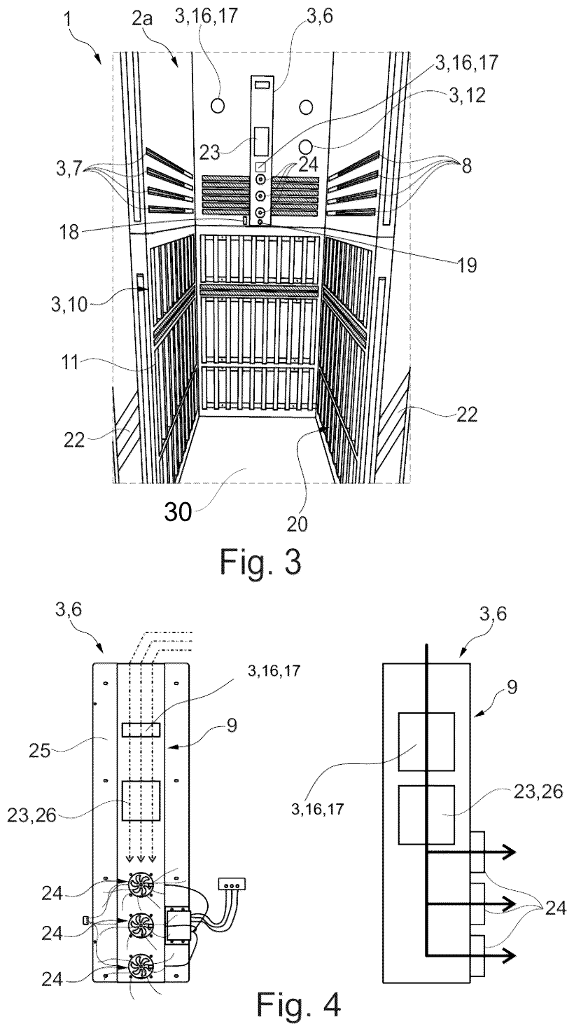

FIG. 3 shows a purely schematic perspective view of the interior space 2a of the application cabin 2a of the device 1 according to the invention. Here, the application apparatuses 3 comprise the ion apparatus 6, the lighting apparatus 7, the heating apparatus 10, the aromatherapy apparatus 16, the ventilation apparatus 13, and the sound apparatus 12. Through the combination of the individual application apparatuses 3 with the ion apparatus 6, an improved cosmetic effect can be achieved, compared to the individual cosmetic application through the individual application apparatuses 3. On the floor, a vibration apparatus 30 is provided, which can cause the human body to vibrate.

FIG. 4 shows purely schematic views of the ion apparatus 6 for cosmetic application, which is used within the device 1 according to the invention. The ion apparatus 6 comprises an ion source unit 23. The ion source unit 23 comprises three high-voltage cascades and three brush units 26 for ionizing the air. The air is drawn in through three fan units 24 through an ion channel 9 with a rigid wall 25. The fan units 24 are designed as axial fans 24. The axial fans 24 are arranged on top each other in a vertical direction so that the entire upper body of a person can be supplied with ionized air. Beyond that, the individual fan units 24 can also be controlled individually. The ion channel 9 with the rigid wall 25 results in a particularly low flow resistance. Here, the fragrance unit 17 of the application apparatus 3 designed as an aromatherapy apparatus 16 is arranged in the ion channel 9, so that the fragrance is distributed directly through the fan units 24 into the interior space 2a of the application cabin. Fragrance samples are provided via replaceable cartridges 17a, which are held in an exchangeable holder. The fragrance sample can be fed directly into the interior space with the ionized air by means of a pump 17b through injection nozzles.

When using the device 1, the user data, such as body size, weight, and age, is first recorded in the control unit 4 of the operating unit 5. The control unit 4 derives application parameters from the user data. These include the application duration, the application intensity of the individual application apparatuses, or the like. The ion concentration of the ionization device 6 is also adjustable. The individual cosmetic applications are subsequently coordinated through the individual application apparatuses 3, in particular their temporal sequence, and an application plan is created. The individual application apparatuses 3 are subsequently controlled according to the application plan. Overall, an improved cosmetic effect can be achieved through that.

Regarding the term ionized air: Electrosmog in our environment causes the concentration of negatively charged ions (anions) in the air we breathe to steadily decrease, while the production of positively charged ions (cations) in the air we breathe steadily increases, for example due to cell phone towers, smartphones, WLAN, etc.

The maximum concentration of anions found in nature in the air can be in the area of 5000 anions per cm³ of ambient air. The standard concentration in urban environments can be between 200 (office) and 1200 per cm³ of ambient air in parks and in the open. At the seaside, in the mountains or in forests, the standard concentration can be up to approximately 2500 anions per cm³ of ambient air. In wooded areas with waterfalls, the standard concentration can even be up to 5000 anions per cm³ of ambient air.

The ion apparatus 6 can enrich the air with at least 10 million anions per cm³ (immediately near the brushes of the cascades) by discharging the high voltage of 12 kV at the tips of the 3 brushes. At a distance of in particular 200 to 300 mm from the ion source (brush), the user receives a constant concentration of at least 1 million anions per cm³ of air from the ion channel.

Effect on the human organism: The body can in particular use more anions for metabolic processes, cell growth, and regeneration. Preferably, anions have an antibacterial effect and can increase performance and promote sleep. Anions are in particular essential for the human organism.

In general, there should always be more anions than cations in the air available to a person. A deficit in the ratio of negatively charged ions to positively charged ions in particular very often can be one of the reasons for fatigue, lack of motivation, depression, and insomnia.

What is claimed is:

1. A device for cosmetic application, comprising:
an application cabin including:
an interior space;
application apparatuses; and
a control unit, the application apparatuses being individually controllable through the control unit via an operating unit,
wherein at least one of the application apparatuses comprises an ion apparatus to supply ionized air into the interior space.

2. The device of claim 1, wherein at least one of the application apparatuses comprises a lighting apparatus with at least one light emitting diode (LED) unit for applying light in the interior space.

3. The device of claim 1, wherein at least one of the application apparatuses comprises a heating apparatus with an infrared unit for applying heat in the interior space.

4. The device of claim 1, wherein at least one of the application apparatuses comprises a a sound apparatus for audiophile application.

5. The device of claim 1, wherein at least one of the application apparatuses comprises a a ventilation apparatus providing rapid ventilation through a ceiling of the application cabin to cause a thermal effect of a rapid drop in temperature.

6. The device of claim 1, wherein at least one of the application apparatuses comprises an aromatherapy apparatus comprising at least one fragrance unit for aromatherapy application.

7. The device of claim 1, wherein the operating unit comprises a tablet computer.

8. The device of claim 1, further comprising:
a temperature sensor unit for monitoring a temperature in the interior space of the application cabin.

9. The device of claim 1, further comprising:
a distance monitoring unit for monitoring a user position in the application cabin.

10. The device of claim 1, wherein the application cabin is sized to enable a person to be positioned within the interior space.

11. The device of claim 1, further comprising:
a vibration unit.

12. The device of claim 1, wherein the ion apparatus comprises:
an ion channel for guidance of air;
an ion source unit for generating negatively charged ions in the air, the ion source unit comprising three high-voltage cascades for ionizing the air; and
a fan unit for conducting the air.

13. The device of claim 12, wherein the ion apparatus comprises three brush units for ionizing the air.

14. The device of claim 12, wherein the ion channel comprises a rigid metal wall.

15. The device of claim 12, wherein the fan unit comprises three axial fans that direct the ionized air into the interior space of the application cabin.

16. A method for operating the device of claim 1, the method comprising:
recording, via the operating unit, user data, the user data include weight, age, and height of a user;
determining application parameters from the user data, the application parameters including an application duration and an application intensity of individual ones of the application apparatuses;
creating an application plan for coordinating individual cosmetic applications by the individual ones of the application apparatuses, including a temporal sequence of applications; and
controlling the individual ones of the application apparatuses using the application plan.
